(19) United States
(12) Patent Application Publication
(10) Pub. No.: US 2026/0168796 A1
(43) Pub. Date: Jun. 18, 2026

(54) SYSTEMS AND METHODS FOR VEHICLE LOCALIZATION

(71) Applicant: Stack AV Co., Mount Pleasant, PA (US)

(72) Inventors: Konstantinos BATSOS, Fremont, CA (US); Yaohua XU, Lynnwood, WA (US); Xxx XINJILEFU, Pittsburgh, PA (US); Yuqing TANG, Davie, FL (US)

(73) Assignee: Stack AV Co., Mount Pleasant, PA (US)

(21) Appl. No.: 19/418,543

(22) Filed: Dec. 12, 2025

Related U.S. Application Data
(63) Continuation of application No. PCT/GR2024/050009, filed on Dec. 18, 2024.

(51) Int. Cl. G01C 21/16; G01C 21/00

(52) U.S. Cl. CPC G01C 21/165; G01C 21/3815

(57) ABSTRACT

A method for localizing a vehicle is provided. The method comprises receiving map data comprising mapped roadway feature positions, including a line segment, in a global coordinate system; receiving detection data comprising detected roadway feature positions, including a line segment, in a vehicle coordinate system; receiving a vehicle pose at an earlier time; determining association data between the mapped roadway features and the detected roadway features based on the pose and at least one of: a distance between a detected roadway feature point and a mapped roadway feature line segment or a distance between a mapped roadway feature point and a detected roadway feature line segment; determining an alignment transformation, based on the association data, that minimizes an alignment distance between a mapped roadway feature position and a detected roadway feature position; and computing an updated vehicle pose based on the map data and the alignment transformation.

### CROSS-REFERENCE TO RELATED APPLICATIONS

This application is a bypass continuation application of International Application No. PCT/GR2024/050009, filed on Dec. 18, 2024, the entire contents of which is incorporated herein by reference.

### FIELD

The present disclosure relates generally to vehicle localization, and more specifically to aligning mapped features and detected roadway features in autonomous vehicle systems.

### BACKGROUND

Autonomous and semi-autonomous vehicles rely on accurate localization within their environment to ensure safe and efficient navigation and/or driver assistance. Localization typically involves determining a vehicle's precise position and orientation, or pose, by comparing environmental or roadway features detected by a vehicle's perception system, for example including optical and/or LiDAR sensors, to features included in preexisting map data. In some instances, vehicle localization according to known techniques may involve point cloud registration, in which a point cloud captured by a vehicle's LiDAR sensors is aligned with or registered to a reference point cloud or map of the environment. With LiDAR point clouds utilizing millions of points to render the vehicle's surroundings, reference point clouds may be correspondingly dense. Processing such large datasets may require significant computational power and time to determine a vehicle's pose.

For example, known approaches such as those based on Random Sample Consensus (RANSAC) may pick a random subset of points to compute an alignment between mapped and detected roadway features, and may then test this alignment using a larger set of points, repeating the process until a sufficiently accurate alignment solution is found. RANSAC-based processes may use the point cloud dataset as is, without extracting features such as edges or surfaces, and without weighting associations based on measurement uncertainty. Such a data processing approach may not take into account the type or shape of features being compared may require high-definition map data in the form of large point clouds to generate an accurate alignment and/or vehicle pose solution. Such large datasets and associated redundancies may increase computational burden and strain network bandwidth without providing significant benefits. Further, because autonomous vehicles process and react to information in real-time, alignment solutions may need to be generated rapidly. Known techniques based on large datasets may thus be insufficient for the timely decision-making that is necessary for navigation, collision avoidance, and maintenance of vehicle control.

### SUMMARY

Disclosed herein are systems and methods for localizing a vehicle by associating mapped and detected roadway features, determining an alignment transformation that minimizes the positional error between the two sets of features, and computing a pose of the vehicle based on the alignment transformation. Instead of utilizing large datasets and randomized approaches to alignment generation, disclosed methods may instead leverage object type and/or shape information produced by a vehicle's perception system to ensure only similar features are associated. For example, both a vehicle's perception system and a set of map data may include positions of roadway features in the form of points connected into one or more line segments, for example corresponding to a lane line or roadway pole, while positions of other roadway features such as traffic lights or traffic signs may be represented as singular points. By generating one-to-one correspondences that match lines with lines and points with points, the techniques disclosed herein may associate identified environmental or roadway features in mapped and detected data, instead of all points in a raw point cloud, and weight features based on measurement uncertainty. Thus, disclosed methods may provide accurate alignment transformation and/or vehicle pose computation while using significantly smaller datasets relative to known techniques.

To compute an alignment transformation that aligns a set of mapped roadway feature positions to a set of detected roadway feature positions (and/or vice versa), disclosed systems may first determine associations between the two sets of features. Associations may be based on pre-existing high-definition map data including positions of mapped roadway features in a global coordinate system, and detection data including positions of roadway features detected by the vehicle's perception system. Mapped roadway feature positions may be converted to a local Cartesian coordinate system and optionally projected onto a planar surface defined by the local coordinate system. For example, if the local coordinate system is centered on an approximate position of the vehicle and defined by easterly, northerly, and upward directions, an exemplary system may project mapped roadway feature positions onto the east-north plane that is approximately parallel to the roadway. Mapped roadway feature positions may then be converted from the local Cartesian coordinate system to the vehicle coordinate system.

Next, systems disclosed herein may compute an alignment distance between a mapped and detected roadway feature position point. This alignment distance may account for uncertainty models taking into account positional uncertainty associated with mapped and/or detected roadway feature position measurements. For comparisons between mapped and detected points, the alignment distance may represent the point-to-point distance, while line-to-line distances may be generated by averaging distances for a given line segment between points in the line segment and a projection of those points onto a mapped line segments. These distances between two features positions may contribute to a cost function that may additionally take into account semantic information, such as the color and/or type of roadway features, that may be included with mapped and/or detection data. This cost function may be higher when features are further apart and/or have different semantic information, relative to features that are closer together and/or have similar semantic information.

Next, systems disclosed herein may utilize a branch and bound approach to iteratively eliminate unpromising associations with cost functions that exceed a cost threshold, optionally considering directional consistency with previously generated associations. From a resulting set of associations with cost functions that fall below the cost threshold, the system may select the lowest cost association for a particular roadway feature. In this way, a system may generate pairings between mapped and detected roadway feature positions that represent the best association for each roadway feature. The best association may be a part of the largest possible set of associations with the lowest cumulative cost that results in a rigid transformation aligning the roadway features to the mapped features.

Next, disclosed systems may utilize these sets of pairings or associations to generate a first transformation matrix, based on the initial or prior pose of the vehicle, that represents an initial estimation of the transformation required to align the mapped and detected roadway feature positions. A system may then iteratively compute a transformation matrix using a nonlinear solver based on an objective function that sums alignment distances between the mapped and detected points and/or lines that make up each association. These alignment distances may be computed at each iteration of the solver and may be weighted by the positional uncertainty of each association, for example representing the measurement of uncertainty of the mapped and/or detected roadway feature position making up the association. The nonlinear solver may continue to iterate until a computed transformation matrix minimizes the objective function, representing a best alignment transformation for a set of mapped and detected roadway features.

This transformation matrix may be used to localize the vehicle with lane-level precision, and to transform the mapped and/or detected roadway features to align one set with the other. For example, the mapped roadway features may be transformed to align with the detected roadway features and used in combination with the detected roadway features as inputs to one or more control systems of, for example, an autonomous vehicle. This increase in accuracy and reliability of information about roadway features near the vehicle may enable control systems of an autonomous vehicle to make more faster, more precise, and safer decisions in real time.

In some embodiments, a method for localizing a vehicle is provided, the method comprising receiving map data comprising a plurality of mapped roadway feature positions, wherein at least one of the plurality of positions is represented by a point in a global coordinate system and at least one of the plurality of positions is represented by a line segment comprising two points in the global coordinate system; receiving detection data comprising a plurality of detected roadway feature positions, wherein at least one of the plurality of positions is represented by a point in a vehicle coordinate system and at least one of the plurality of positions is represented by a line segment comprising two points in the vehicle coordinate system; receiving a pose of the vehicle at an earlier time; determining association data between one or more of the plurality of mapped roadway feature positions and one or more of the plurality of detected roadway feature positions based on the pose of the vehicle at the earlier time and at least one of a distance between a point representing a detected roadway feature position and a line segment representing a mapped roadway feature position; or a distance between a point representing a mapped roadway feature position and a line segment representing a detected roadway feature position; determining an alignment transformation, based on the association data, that minimizes an alignment distance between the one or more of the plurality of mapped roadway feature positions and the one or more of the plurality of detected roadway feature positions; and computing an updated pose of the vehicle based on the map data and the alignment transformation.

In some embodiments, at least one of the plurality of mapped roadway features or the plurality of detected roadway features is at least one of a lane line, a roadway sign, a traffic light, a roadway marking, or a roadway pole. In some embodiments, the pose of the vehicle at an earlier time is based on a signal from at least one of a satellite-based positioning system or an inertial measurement device. In some embodiments, the detection data was generated by at least one sensor selected from a group comprising an optical sensor, a LiDAR sensor, and a radar sensor. In some embodiments, determining the association data comprises: converting the one or more of the plurality of mapped roadway feature positions from the global coordinate system to the vehicle coordinate system. In some embodiments, determining the association data comprises converting the one or more of the plurality of mapped roadway feature positions from the global coordinate system to a local Cartesian coordinate system and from the local Cartesian coordinate system to the vehicle coordinate system. In some embodiments, determining the association data comprises projecting the one or more of the plurality of mapped roadway feature positions onto a planar surface defined by the local Cartesian coordinate system. In some embodiments, determining the association data comprises eliminating a first association between a first mapped roadway feature position and a first detected roadway feature position based on a determination that a first cost function of the first association exceeds a cost threshold; and selecting, for inclusion in the association data, a second association between a second mapped roadway feature position and a second detected roadway feature position based on a determination that a second cost function of the second association is lower than a third cost function of a third association. In some embodiments, the cost function is based on at least one of an alignment distance between a mapped roadway feature position of the one or more of the plurality of mapped roadway feature positions and a detected roadway feature position of the one or more of the plurality of detected roadway feature positions; or an attribute of at least one of the mapped roadway feature or the detected roadway feature, wherein the attribute is selected from a group comprising: a color and a type. In some embodiments, the alignment distance is based on a distance between a point representing a mapped roadway feature position of the one or more of the plurality of mapped roadway feature positions and a point representing a detected roadway feature position of the one or more of the plurality of detected roadway feature positions; and the alignment distance is based on at least one of a Mahalanobis distance, a Euclidean distance, or a Manhattan distance. In some embodiments, the Mahalanobis distance is based on at least one of: a map uncertainty model based on measurement uncertainty associated with a satellite-based positioning system; or a detection uncertainty model based on measurement uncertainty associated with a perception system of the vehicle. In some embodiments, the alignment distance is based on a distance between at least one of a point representing the detected roadway feature position and a projection of the point onto a line segment representing the mapped roadway feature position; or a point representing the mapped roadway feature position and a projection of the point onto a line segment representing the detected roadway feature position; and the alignment distance is based on at least one of a Mahalanobis distance, a Euclidean distance, or a Manhattan distance. In some embodiments, the Mahalanobis distance is based on at least one of a map uncertainty model based on measurement uncertainty associated with a satellite-based positioning system; or a detection uncertainty model based on measurement uncertainty associated with a perception system of the vehicle. In some embodiments, determining the association data comprises computing a difference between an angle of a first alignment distance vector and an angle of a second alignment distance vector; and eliminating an association between a mapped roadway feature position and a detected roadway feature position based on a determination that the difference exceeds an error threshold; wherein the first alignment distance vector is based on a first alignment distance between a first mapped roadway feature position and a first detected roadway feature position; and wherein the second alignment distance vector is based on a second alignment distance between a second mapped roadway feature position and a second detected roadway feature position. In some embodiments, determining the association data further comprises generating a data structure comprising at least one of an identifier of the second mapped roadway feature position and an identifier of the second detected roadway feature position; or a position of the second mapped roadway feature position and a position of the second detected roadway feature position. In some embodiments, minimizing the alignment distance between the one or more of the plurality of mapped roadway feature positions and the one or more of the plurality of detected roadway feature positions comprises minimizing an objective function. In some embodiments, the objective function is based on the association data; and uncertainty model data comprising a positional uncertainty of the one or more of the plurality of mapped roadway feature positions in the association data and a positional uncertainty of the one or more of the plurality of detected roadway feature positions in the association data; wherein the uncertainty model data is based on a map uncertainty model based on measurement uncertainty associated with a satellite-based positioning system; and a detection uncertainty model based on measurement uncertainty associated with a perception system of the vehicle. In some embodiments, the objective function is based on a sum of alignment distances, wherein each alignment distance is based on one of the one or more of the plurality of mapped roadway feature positions in the association data and one of the one or more of the plurality of detected roadway feature positions in the association data. In some embodiments, at least one of the alignment distances of the sum of alignment distances is weighted based on the uncertainty model data. In some embodiments, at least one of the alignment distances of the sum of alignment distances is based on a point representing a mapped roadway feature position of the one or more of the plurality of mapped roadway feature positions and a point representing a detected roadway feature position of the one or more of the plurality of detected roadway feature positions; and at least one of a Mahalanobis distance, a Euclidean distance, or a Manhattan distance. In some embodiments, at least one of the alignment distances of the sum of alignment distances is based on at least one of a point representing a detected roadway feature position and a projection of the point onto a line segment representing a mapped roadway feature position; or a point representing a mapped roadway feature position and a projection of the point onto a line segment representing a detected roadway feature position; and at least one of a Mahalanobis distance, a Euclidean distance, or a Manhattan distance. In some embodiments, minimizing the objective function comprises generating one or more alignment transformations using a nonlinear solver. In some embodiments, the method further comprises updating the map data, based on the association data, to include the attribute of the at least one of the mapped roadway feature or the detected roadway feature. In some embodiments, the method further comprises transforming, based on the alignment transformation, at least one feature position selected from a group consisting of: the plurality of mapped roadway feature positions and the plurality of detected roadway feature positions. In some embodiments, transforming the at least one feature position comprises transforming, based on the alignment transformation, the plurality of mapped roadway feature positions to minimize the alignment distance between the one or more of the plurality of mapped roadway feature positions and the one or more of the plurality of detected roadway feature positions. In some embodiments, the method further comprises providing the transformed plurality of mapped roadway feature positions as an input to one or more control systems of the vehicle. In some embodiments, transforming the at least one feature position comprises transforming, based on the alignment transformation, the plurality of detected roadway feature positions to minimize the alignment position between the plurality of mapped roadway feature positions and the plurality of detected roadway feature positions; and converting the transformed plurality of detected roadway feature positions from the vehicle coordinate system to the global coordinate system. In some embodiments, the method further comprises providing the transformed plurality of detected roadway feature positions as an input to one or more control systems of the vehicle.

In some embodiments, a system for localizing a vehicle is provided, the system comprising one or more processors and memory storing instructions that, when executed by the one or more processors, cause the system to receive map data comprising a plurality of mapped roadway feature positions, wherein at least one of the plurality of positions is represented by a point in a global coordinate system and at least one of the plurality of positions is represented by a line segment comprising two points in the global coordinate system; receive detection data comprising a plurality of detected roadway feature positions, wherein at least one of the plurality of positions is represented by a point in a vehicle coordinate system and at least one of the plurality of positions is represented by a line segment comprising two points in the vehicle coordinate system; receive a pose of the vehicle at an earlier time; determine association data between one or more of the plurality of mapped roadway feature positions and one or more of the plurality of detected roadway feature positions based on the pose of the vehicle at the earlier time and at least one of a distance between a point representing a detected roadway feature position and a line segment representing a mapped roadway feature position; or a distance between a point representing a mapped roadway feature position and a line segment representing a detected roadway feature position; determine an alignment transformation, based on the association data, that minimizes an alignment distance between the one or more of the plurality of mapped roadway feature positions and the one or more of the plurality of detected roadway feature positions; and compute an updated pose of the vehicle based on the map data and the alignment transformation.

In some embodiments, a non-transitory computer readable storage medium storing instructions for localizing a vehicle is provided, wherein the instructions, when executed by one or more processors of an electronic device, cause the device to receive map data comprising a plurality of mapped roadway feature positions, wherein at least one of the plurality of positions is represented by a point in a global coordinate system and at least one of the plurality of positions is represented by a line segment comprising two points in the global coordinate system; receive detection data comprising a plurality of detected roadway feature positions, wherein at least one of the plurality of positions is represented by a point in a vehicle coordinate system and at least one of the plurality of positions is represented by a line segment comprising two points in the vehicle coordinate system; receive a pose of the vehicle at an earlier time; determine association data between one or more of the plurality of mapped roadway feature positions and one or more of the plurality of detected roadway feature positions based on the pose of the vehicle at the earlier time and at least one of a distance between a point representing a detected roadway feature position and a line segment representing a mapped roadway feature position; or a distance between a point representing a mapped roadway feature position and a line segment representing a detected roadway feature position; determine an alignment transformation, based on the association data, that minimizes an alignment distance between the one or more of the plurality of mapped roadway feature positions and the one or more of the plurality of detected roadway feature positions; and compute an updated pose of the vehicle based on the map data and the alignment transformation.

In some embodiments, any of the features of any of the embodiments described above and/or described elsewhere herein may be combined, in whole or in part, with one another. Additional advantages will be readily apparent to those skilled in the art from the following figures and detailed description. The aspects and descriptions herein are to be regarded as illustrative in nature and not restrictive.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying figures of which:

FIG. 1A depicts an exemplary system for localizing a vehicle, according to some embodiments.

FIG. 1B depicts an exemplary process for localizing a vehicle, according to some embodiments.

FIG. 2 depicts an exemplary process for determining a best association between mapped and detected roadway features, according to some embodiments.

FIG. 3 depicts an exemplary process, that may be combined with the exemplary process depicted in FIG. 2, for eliminating an association based on compatibility with one or more other associations, according to some embodiments.

FIG. 4A depicts exemplary associations without consistency correction, according to some embodiments.

FIG. 4B depicts exemplary associations with consistency correction, according to some embodiments.

FIG. 5 depicts an exemplary process for determining a best alignment between mapped and detected roadway features, according to some embodiments.

FIG. 6 depicts an exemplary computing system, according to some embodiments.

### DETAILED DESCRIPTION

Disclosed herein are systems and methods for localizing a vehicle and enriching data forming the basis of autonomous and/or semi-autonomous vehicle control decisions by aligning mapped and detected roadway features. An exemplary system may accomplish this alignment by first associating sets of mapped and detected roadway by making one-to-one correspondences, for example matching pairs of roadway features represented by points and/or pairs of roadway features represented by lines. These one-to-one correspondences may be based on map and detection data which may use points to represent discrete roadway features, for example traffic lights and/or traffic signs. Map and detection data may additionally or alternatively use line segments formed of points to represent linear roadway features, for example lane line edges and/or roadway poles. These data sources may further include semantic information, for example the color of a lane line or the type of a traffic sign. Such information may allow an exemplary system to compute a cost of each of a plurality of candidate associations between map and detection data for a particular roadway feature. The cost of a given candidate association may increase the further the feature positions in the mapped and detection data are from each other, and/or may increase the greater the difference in semantic information is between the two features. An exemplary system may use costs of each candidate association to execute a branch and bound process for a particular roadway feature to distinguish between promising and unpromising associations and select a best association for each feature. As discussed below, this process may take into account associations chosen for other roadway features, for example ensuring that vectors representing the alignment distance between roadway features of each association of a set of associations are pointing in approximately the same direction.

Thus, disclosed techniques may distinguish the representation of discrete and linear roadway feature positions, and utilize of semantic information classifying one or more of the features, to improve generation of associations between features. This improvement may be especially apparent over known techniques utilizing, for example, RANSAC-based approaches to compare large point cloud datasets representing mapped and detected feature positions. Such approaches may not distinguish the cost of comparing a point representing a traffic sign to a point representing a lane line edge, for example, requiring multiple iterations each comparing a subset of points from each data set, to arrive at an alignment solution.

Instead, systems and methods disclosed herein may seek to associate point features with other point features and line features with other line features, accounting for additional known feature classifications in semantic data, to produce a best association for each roadway feature. This best association may take into account positional uncertainty associated with mapped and/or detected roadway feature positions and may be generated based on compatibility for each point, for example associating point or line features closest to one another. This best association may additionally account for joint compatibility between multiple associations, for example determining that vectors representing the alignment distance between roadway features of each association of a set of associations are pointing in approximately the same direction.

Once a set of best associations has been generated, an exemplary system may determine an alignment transformation matrix based on the association data. This alignment transformation may be generated using a nonlinear solver that iteratively generates alignment transformation matrices to minimize an objective function. This objective function may represent a sum of alignment distances between mapped and roadway features of each association, weighted by the positional uncertainty associated with measurement of each mapped and/or detected roadway feature position. The nonlinear solver may select the best alignment transformation based on a minimization of the objective function and may use the resulting alignment transformation matrix to compute an updated pose of the vehicle, for example determining the position of the vehicle to the accuracy of a lane line assignment. The system may further align mapped to detected roadway feature positions to form an enriched dataset. For example, the result of this process may augment detected roadway feature positions with mapped roadway feature positions in the vehicle coordinate system. This enriched dataset may be used as an input to one or more control systems of the vehicle to improve the vehicle's autonomous and/or semi-autonomous control systems'understanding of the vehicle's surrounding, in turn improving the safety and efficiency of the systems'decision-making.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed terms. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, storage medium, such as, but not limited to, any type of disk, including floppy disks, USB flash drives, external hard drives, optical disks, CD-ROMs, magneto-optical disks, read-only memories (ROMs), random access memories (RAMs), EPROMs, EEPROMs, magnetic or optical cards, application-specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear in the description below. In addition, the present invention is not described with reference to any particular programming language. It will be appreciated that a variety of programming languages may be used to implement the teachings of the present disclosure as described herein.

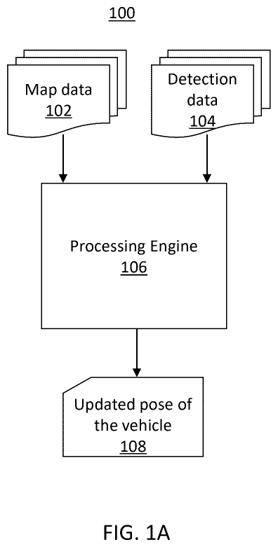

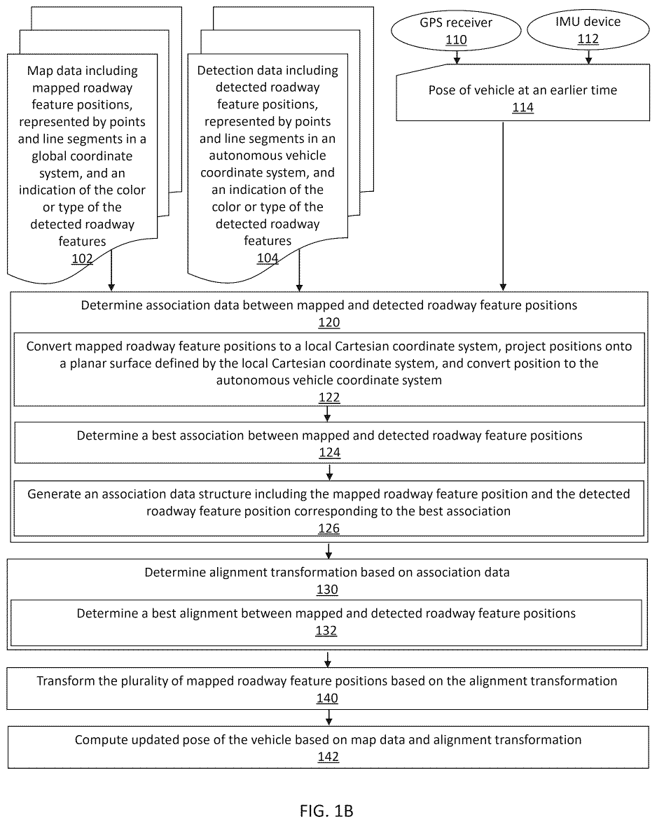

FIG. 1A depicts an exemplary system 100 for localizing a vehicle. System 100 may include inputs in the form of one or more sources of data relating to roadway features surrounding the vehicle. For example, system 100 may receive map data 102 that may include, for example, data based on a preexisting high-definition map. Such high-definition maps may include data generated by vehicles equipped with a range of sensors, for example LiDAR, optical, GPS, and/or radar sensors to generate extensive data with respect to features adjacent to and a part of roadways along which the vehicles are traveling. For example, high-definition maps may include HERE's HD Live Map, OpenStreetMap, and/or Apollo HD Maps. Such high-definition maps may include the position of one or more mapped roadway features such as lane lines or lane line edges, road edges, crosswalks, traffic signs, traffic lights, poles and/or landmarks, and/or guardrails and/or barriers. Map data 102, generated based on such high-definition maps, may include identification of one or more mapped roadway features, for example one or more of the aforementioned roadway features, identifying a set of points and/or other representations as belonging to discrete features.

For example, map data 102 may include an identification of the position of one or more points corresponding to a discrete roadway feature, for example a traffic sign and/or a traffic light. In some implementations, the one or more points may correspond to the geometric centroid of the volume of the shape, for example the volume of a traffic sign and/or a traffic light. In other implementations, the one or more points may correspond to a bounding box detected and associated with a particular shape, for example a traffic sign and/or a traffic light. In some implementations, the one or more points may correspond to the centroid of the bounding box and/or to one or more of the corners defining the bounding box.

For example, map data 102 may include an identification of the position of one or more line segments corresponding to a linear roadway feature, for example a lane line or lane line edge, a road edge, and/or a guardrail. Such line segments may be formed on the basis of a determined linear relationship between two or more detected points, and such line segments may be combined to form a polyline on the basis of a determined linear relationship between two or more line segments. Map data 102 may include the position of the points that form the one or more line segments, for example the two or more points used to form a line segment. The position of each point and/or line segment may be defined in a global coordinate system, for example a global Cartesian coordinate system such as Earth-Centered, Earth-Fixed (ECEF) that may represent roadway feature positions based on position along three axes, for example X, Y, and Z. Additionally or alternatively, the position of each point and/or line segment may be defined in a global geodetic coordinate system such as World Geodetic System 1984 (WGS84) and/or North American Datum 1983(NAD83 ) that may represent roadway feature positions using latitude, longitude, and altitude based on an ellipsoidal model of the Earth's surface.

Map data 102 may further include semantic information, that may provide a classification and/or further context for one or more of the identified roadway features. For example, map data 102 may include an indication of one or more types, one or more colors, and/or one or more additional identifiers such as text and/or arrow direction of one or more of the identified roadway features. For example, map data 102 may include an identification of a particular traffic sign as having type “stop sign,” color “red,” and/or additional identifier as “text: STOP.” Additionally or alternatively, map data 102 may include an identification of a particular lane line as having type “boundary lane line,” and color “yellow.” As discussed below, this semantic information may improve the accuracy of associations and thus the accuracy of a computed alignment transformation and/or vehicle pose.

Each of the above-described mapped roadway feature identifications within map data 102 may thus include position information, for example one or more point positions and/or one or more line positions (e.g. each including two or more point positions), and/or semantic information, for example one or more types, colors, and/or additional identifiers associated with each identified feature. Semantic information may be stored within map data 102 as metadata and/or attribute data, thereby accessible to exemplary system 100 for use in vehicle localization.

System 100 may additionally receive detection data 104 from the vehicle's perception system. Detection data 104 may be generated by, for example, one or more LiDAR sensors, one or more optical sensors, and/or one or more radar sensors of the vehicle. Similar to map data 102, detection data 104 may include the position of one or more detected roadway features such as lane lines or lane line edges, road edges, crosswalks, traffic signs, traffic lights, poles and/or landmarks, and/or guardrails and/or barriers. These positions may be identified in detection data 104, as in map data 102, based on a point and/or line segment, for example corresponding to the geometric centroid and/or one or more points associated with a bounding box defining the feature. The positions of linear roadway features such as lane lines or lane line edges, road edges, and/or guardrails may be indicated using line segments based on a determination of a linear relationship between two or more points. Such line segments may be combined to form a polyline on the basis of a determined linear relationship between two or more line segments. Similar to map data 102, detection data 104 may further include semantic information such as one or more types, colors, and/or additional identifiers associated with one or more detected roadway features. This semantic information may be stored as metadata and/or attribute data within detection data 104.

Unlike map data 102, however, detection data 104 may be generated in real-time by the vehicle's perception system. Detection data 104 may be defined based on a vehicle coordinate system, for example a coordinate system defined by the structure of the vehicle. An exemplary vehicle coordinate system may be defined with axes corresponding to the vehicle's forward direction (F), left direction perpendicular to its forward direction (L), and upward direction perpendicular to both its forward and left directions (U), thereby forming an “FLU” vehicle coordinate system. For example, a vehicle may have two sensor assemblies, including LiDAR, optical, and/or radar sensors. The two sensor assemblies may be placed at front-left and a front-right positions: at similar elevations on the vehicle, at similar distances from the front of the vehicle, and at similar distances from the left and right sides of the vehicle respectively. In this scenario, an FLU vehicle coordinate system may be located at a center point between the two sensor assemblies, left direction point from the center point to the left sensor assembly, the forward direction pointing from the center point to the direction of travel and perpendicular to the left direction, and the upward direction pointing upward from the center point and perpendicular to both the forward and left directions.

System 100 may additionally include a processing engine 106 such as a computer that may include one or more processing units such as a central processing unit and/or graphics processing unit along with memory management units. Processing engine 106 may carry out a plurality of computational steps to execute a process to localize a vehicle, computing an alignment transformation and/or updated pose of the vehicle 108, as described in further detail below.

FIG. 1B depicts an exemplary process for localizing a vehicle. As described above, exemplary system 100 may include input data in the form of map data 102 and detection data 104, containing positions of points and/or line segments corresponding to mapped and detected roadway features respectively. One or both may additionally include semantic or context information about one or more of the mapped and/or detected roadway features, for example the one or more types, colors, and/or additional identifiers corresponding to each. As discussed above, map data 102 may include mapped roadway feature positions defined within a global coordinate system such as a geodetic coordinate system, and detection data 104 may include detected roadway features defined within a vehicle coordinate system such as a FLU vehicle coordinate system.

System 100 may additionally include an input representing the pose, for example the position and orientation, of the vehicle at an earlier point in time 114. This earlier pose or pose prior may be utilized by system 100 to produce an initial alignment between new mapped and detected roadway feature positions contained within map data 102 and detection data 104 respectively. This initial alignment may be used to determine associations between mapped and detected features, and to compute and updated alignment transformation and/or vehicle pose based on said associations.

Earlier vehicle pose 114 may be based on an initial estimate of vehicle's pose, for example an estimate produced before the first cycle of the localization process described herein has completed. Such an initial estimate may in turn be based on the position of the vehicle within a global coordinate system such as a geodetic coordinate system and/or may be received from a satellite-based positioning system. For example, system 100 may receive latitude, longitude, and/or altitude information corresponding to the vehicle's position from a GPS receiver 110. Such an initial estimate may be based additionally on an inertial measurement made with respect to the vehicle's motion by, for example, an IMU device 112. IMU device 112 may include one or more accelerometers and/or one or more gyroscopes to provide an indication of the heading and/or orientation of the vehicle while the vehicle is in motion. Thus, GPS data such as that generated by GPS receiver 110 may provide a position of the vehicle and/or inertial data such as that generated by IMU device 112 may provide an orientation of the vehicle, together providing an initial estimate of the vehicle's pose or localization.

After the vehicle completes its first localization cycle, as described in further detail below, an updated or refined vehicle pose 142 may be generated. As the vehicle continues to travel along a roadway, perceiving additional detected roadway features and receiving additional mapped roadway features, system 100 may combine these mapped and detected roadway feature positions in map data 102 and detection data 104 with the updated pose 142 of the prior cycle, making it the earlier vehicle pose input 114 of the current cycle. Alternatively or additionally, system 100 may take into account input from GPS receiver 110 and/or IMU device 112 to validate the updated pose 142 of the prior cycle and/or to again produce a vehicle pose input 114. For example, system 100 may combine the updated pose 142 of the prior cycle with based on an updated vehicle position and/or orientation generated based on inputs from GPS receiver 110 and/or IMU device 112. This pose input may then serve as a revised starting point to compute associations between mapped and detected features, in turn used to compute an alignment transformation and/or updated vehicle pose 142. This updated pose may then serve as earlier pose input 114 of the following cycle.

In order to produce an alignment between mapped and detected roadway feature positions and use the alignment as a basis for computing an updated pose of the vehicle, system 100 may combine the map data 102, detection data 104, and/or earlier vehicle pose 114 inputs to first determine, at step 120, association data corresponding to one or more associations between mapped and detected roadway features. This association data may include, for each association, the identifier and/or position of the mapped roadway feature and the identifier and/or position of the detected roadway feature determined to represent a pairing with minimal alignment error. As described above, mapped roadway feature positions contained within map data 102 may be defined with respect to a geodetic coordinate system such as WGS84, including a latitude, longitude, and/or altitude of each mapped feature. Detected roadway features contained within detection data 104, on the other hand, may be defined with respect to a vehicle coordinate system such as the FLU vehicle coordinate system, as detailed above. In order to determine associations between the two sets of roadway features, system 100 may convert, at step 122, the mapped roadway feature positions to a local Cartesian coordinate system. The local Cartesian coordinate system may be centered on an approximation of the position of the vehicle as discussed below, for example the center point between two sensor assemblies as discussed above, with axes that may be defined according to one or more cardinal directions. For example, the axes of the local Cartesian coordinate system may be defined by an easterly direction that points east from an approximate position on the vehicle (E), a northerly direction that points north from the same position on the vehicle (N), and an upward direction that points upward from the position on the vehicle (U). This “ENU” local Cartesian coordinate system may be defined by a tangent plane centered on the position of the vehicle. System 100 may partition this tangent plane into multiple tiles using a geohashing function that exponentially divides an ellipsoidal model of the Earths. For example, the tangent plane may be divided into a grid of tiles arranged with three tiles on each side, centered on the vehicle's position in the centermost tile. Each tile may represent a region with a side length of at least 10 meters, at least 50 meters, at least 500 meters, at least 1 kilometer, at least 2 kilometers, at least 3 kilometers, at most 5 kilometers, at most 3 kilometers, at most 2 kilometers, at most 1 kilometer, at most 500 meters, at most 50 meters, and/or at most 10 meters. A zoom level may be associated with the geohashing function such that a zoom level of zero corresponds to a single tile that contains the entire Earth while a zoom level of, for example, 15 corresponds to a tile with a side length of 1 kilometer. The tiles may approximate square shapes at lower zoom levels and transform to trapezoidal shapes with curved edges at higher zoom levels due to the Earth's curvature.

As discussed above, the mapped and detected roadway feature positions may include points and/or line segments. In the case of mapped roadway feature positions, each position may be defined in a geodetic coordinate system based on the latitude, longitude, and/or altitude of each point. These points and/or associated line segments may be converted or transformed from the geodetic coordinate system to the local Cartesian coordinate system, for example the ENU coordinate system, centered on a specified tile origin that serves as the reference point for the vehicle position within the selected tile. To accomplish this, for example, system 100 may first convert each point and/or line segment from the geodetic coordinate system to a global Cartesian coordinate system such as ECEF based on, for example, the WGS84 ellipsoidal model. System 100 may next convert each point and/or line segment from ECEF coordinates to ENU coordinates based on a secondary reference point, such as a geohash associated with a GPS coordinate. This geohash, which may be determined at a specified zoom level as described above, provides a reference point for localization within a defined area that may be centered on an initial or prior position of the vehicle as determined by, for example, GPS receiver 110.

To limit the number of mapped roadway feature positions contained within map data 102 that the system may consider for association and alignment operations, system 100 may limit mapped roadway feature positions to those falling within the three-by-three square grid of tiles within tangent plane of the ENU local Cartesian coordinate system as described above. In this way, the system may avoid considering features too distant from the vehicle to be relevant to meeting its objectives including, for example, navigation, collision avoidance, and vehicle control. Because certain sources of map data 102 may not include altitude data, in some implementations, mapped roadway feature data may be projected, at step 120, onto a planar surface defined by the local Cartesian coordinate system, for example the tangent plane of the ENU local Cartesian coordinate system. This projection onto the tangent plane may involve setting the altitude of the mapped roadway feature positions to zero, effectively treating each position as a 3D point with zero altitude along the upward axis of the ENU local Cartesian coordinate system. By setting mapped and detected roadway feature positions to the same vertical value, association and alignment errors due to mismatched input altitude data may be minimized.

In the case of detected roadway feature positions, each position may be defined in a vehicle coordinate system such as the FLU vehicle coordinate system. In this case, each points and/or associated line segments may be defined as a position along the forward, left, and upward axes relative to a center point or origin on the vehicle, for example the center point between two sensor assemblies.

To ensure the mapped and detected roadway feature positions may be compared and associated within the same coordinate system, system 100 may additionally, at step 122, convert mapped roadway feature positions from the ENU local Cartesian coordinate system to the FLU vehicle coordinate system. To convert mapped roadway feature points and/or associated line segments from the ENU coordinate system to the FLU coordinate system, a single rotational matrix and/or a single translation vector may be applied. The rotational matrix and/or translation vector may be computed on the basis that the ENU coordinate system is centered on the tile origin as discussed above, and the FLU coordinate system is centered on the vehicle position. The conversion may thus take the form of one or more rotations and/or translations, such that points and/or line segments previously defined in the ENU coordinate system may be defined in the FLU coordinate system. The determination of the angles of each rotation and/or the distances of each translation may be based on, for example, feedback from GPS receiver 110 and/or IMU device 112 that may provide an estimation of the vehicle's heading or yaw with respect to the east and north directions. Specifically, the determination may be based on the pose, for example the position and orientation, of the vehicle at an earlier point in time 114 as discussed above. For example, system 100 may translate the mapped roadway feature positions based on the distance between the tile origin and the center of the vehicle, and/or may rotate the roadway feature positions one or more times to align at least the easterly and/or northerly directions of the ENU coordinate system with the forward and left directions of the FLU coordinate system.

Once mapped feature positions have been converted to the vehicle coordinate system, each set of feature positions optionally including semantic information may be utilized to determine associations between mapped and detected features. As mentioned above, associations may be determined between corresponding types of roadway feature positions. That is, mapped roadway feature positions represented by points may be compared to detected roadway feature positions represented by points. Similarly, mapped roadway feature positions represented by line segments may be compared to detected roadway feature positions represented by line segments. Identifiers of points belonging to a line segment and/or a polyline may be stored, along with semantic information, within metadata and/or attribute data of map data 102 and/or detection data 104, and used by system 100 to enable point-to-point and line-to-line comparisons. Thus, by ensuring discrete roadway features such as traffic signs and/or traffic lights are compared to other discrete roadway features, and linear roadway features such as lane lines are compared to other linear roadway features, system 100 may effectively prefilter features for association improving computational efficiency relative to known techniques which may compare mapped and detected points regardless of the type and/or shape of roadway feature they represent.

System 100 may search for associations on the basis of individual compatibility, find the best match between individual mapped and detected positions, and/or on the basis of joint compatibility, checking multiple individual associations for consistency. In both the case of both individual and joint compatibility, system 100 may, at step 124, determine a best association between mapped and detected roadway feature positions. To determine a best association, system 100 may utilize a branch and bound approach to systematically explore possible associations while eliminating unpromising association solutions based on a determination that a cost function exceeds a cost threshold. This may result in a set of cost functions that fall below the cost threshold from which an association representing a minimum cost may be selected.

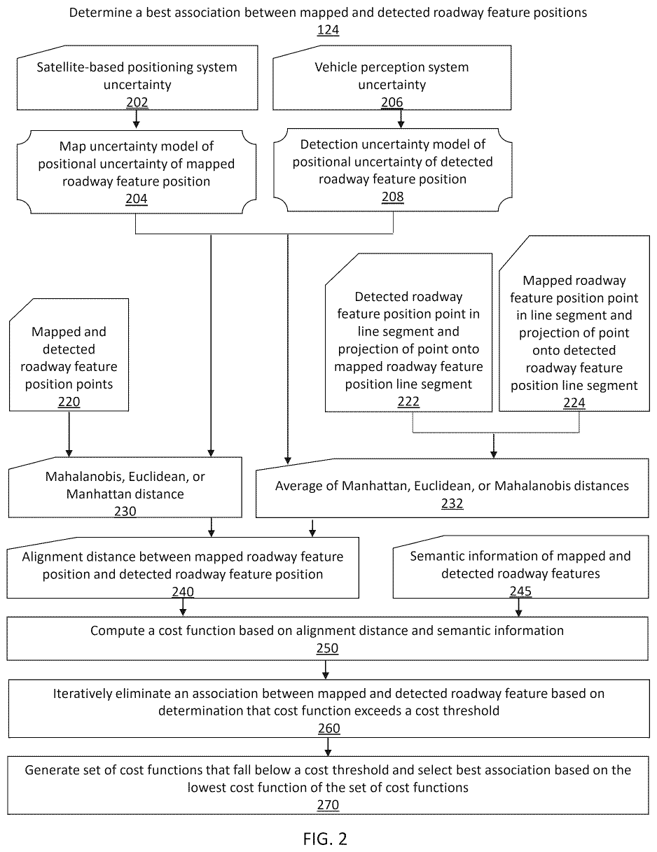

FIG. 2 depicts the process represented by step 124 in greater detail: an exemplary process for determining, on the basis of individual compatibility, e.g. compatibility between individual mapped and detected positions, a best association between a mapped roadway feature and a detected roadway feature. As described above, system 100 may use a branch and bound approach to distinguish between promising and unpromising associations. This distinction may be based on a determination that a cost function exceeds a cost threshold, with unpromising associations exceeding the cost threshold. As depicted in FIG. 2, a cost function computed at step 250 may be based on an alignment distance 240 between the mapped and detected roadway feature positions and/or on semantic information 245 about mapped and/or detected roadway features. Alignment distance 240 may in turn be based on Mahalanobis distance, Euclidean distance, and/or Manhattan distance 230, or an average of Manhattan distances, Euclidean distances, and/or Mahalanobis distances 232 depending on whether a candidate association between positions of a mapped and detected roadway feature is based on a distance between two points or a distance between two line segments and/or polylines.

Measurement uncertainties in generating map data 102 may arise due to precision limitations inherent in satellite-based positioning systems such as GPS. These measurement uncertainties 202 may arise in at least two cases. When the position of a roadway feature is determined from, for example, map data 102, the satellite-based system may be used and may limit the precision of such a determination. Further, when system 100 converts a mapped roadway feature position from the geodetic coordinate system in which it was measured to a local Cartesian coordinate system centered on an approximate position of the vehicle, a current and prior or reference position of the vehicle used for the conversion may be based on, for example, GPS receiver 110 thereby producing a similar precision limitation of said positions. To model this positional uncertainty 202 of mapped roadway feature positions, system 100 may generate map uncertainty model 204 that may be based on probabilistic distributions, such as Gaussian distributions, where a mean represents an expected position, and a covariance matrix captures the variability and correlation between positions along different coordinate axes, reflecting the degree of confidence in the map data. For example, uncertainty model 204 may be generated following conversion of mapped roadway feature positions to a local Cartesian coordinate system such as the ENU coordinate system, and from the ENU coordinate system to the FLU coordinate system. Uncertainty model 204 may thus represent the distribution of possible positions along F, L, and U axes.

Measurement uncertainties in generating detected roadway features may arise due to precision limitations in the one or more sensors making up the perception system of the vehicle, for example one or more LiDAR, optical, and/or radar sensors. Such measurement uncertainties 206 may be a result of environmental factors such as differing lighting, reflectivity, presence of precipitation, and/or occlusions by other roadway actors.

Detections by the vehicle's perception system of objects and/or roadway features located a significant distance from the vehicle may be less accurate and/or less reliable than detections of roadway features located closer to the vehicle. This reduction in accuracy may be a result of a reduction in sensor accuracy, for example accuracy of LiDAR and optical sensors as a function of distance, in addition an attenuation of signal strength based on a distance traveled through an environment, particularly one with precipitation and/or low levels of ambient light. For this reason, system 100 may assign a higher degree of uncertainty to detected roadway features positions located further from the vehicle. This increase in uncertainty as a function of depth, for example depth detected by one or more LiDAR sensors, may be implemented as a threshold, for example increasing by a certain amount at a threshold depth. Additionally or alternatively, uncertainty may be increased linearly and/or exponentially as a function of depth.

To account for these uncertainties, similar to the approach to uncertainty in mapped roadway feature positions, system 100 may generate detection uncertainty model 208 to model uncertainty 206. Model 208 may account for positional uncertainties that may increase with depth as discussed above and may thus be considered conal in nature, with noise and/or uncertainty in model data increasing as the distance from the vehicle increases. Model 208 may additionally or alternatively be based on probabilistic distributions, such as Gaussian distributions, where a mean represents an expected position, and a covariance matrix captures the variability and correlation between positions along different coordinate axes, reflecting the degree of confidence in the detection data.

For a candidate association formed between two points, to compute alignment distance 240, system 100 may compute the Mahalanobis, Euclidean, and/or Manhattan distance 230 between one mapped roadway feature position point and one detected roadway feature position point 220. In some embodiments, using the uncertainty distributions of model 204 and/or 208, system 100 may compute the Mahalanobis distance, accounting for the variability and correlations within the uncertainty distribution associated with one or both of the mapped roadway feature position point and the detected roadway feature position point. For example, system 100 may compute: the Mahalanobis distance between the mapped roadway feature position point and the mean of an uncertainty distribution associated with the detected roadway feature position point, the Mahalanobis distance between the detected roadway feature position point and the mean of an uncertainty distribution associated with the mapped roadway feature position point, and/or the Mahalanobis distance between the means of uncertainty distributions associated with the mapped roadway feature point and the detected roadway feature point. In some embodiments, system 100 may base alignment distance 240 on a computation of the Euclidean distance between the mapped roadway feature position point and the detected roadway feature position point, for example by computing the straight-line distance or square root of the sum of the squared differences between corresponding coordinates of the points. In some embodiments, system 100 may compute the Manhattan distance or L1 norm between the two points by summing the absolute differences of the coordinates of the two points along each dimension of the coordinate system, for example along the F, L, and U dimensions. This Manhattan distance may thus represent the distance between the two points based only on movements or segments that are parallel to each coordinate system axis.

As mentioned above, line segments may be formed of two or more points and may represent positions of linear roadway features such as lane lines. Two or more line segments may be combined to form a polyline representing an extended roadway feature. For a candidate association formed between two line segments and/or polylines, to compute alignment distance 240, system 100 may compute a distance representing the distance between the two line segments and/or polylines. To accomplish this, system 100 may compute an average of the distances between (a) each detected roadway feature position point making up each detected line segment and (b) a projection of each of these points onto the nearest mapped roadway feature line segment 222. For example, system 100 may compute a mapped line segment vector representing a particular mapped line segment, and an error vector representing the direction between a detected roadway feature position point and one of the points forming the particular mapped line segment. System 100 may then project the detected roadway feature position point onto the mapped line segment by projecting the error vector onto the mapped line segment vector, thereby computing a normal or minimum distance between the detected point and the mapped line segment. If the projection of the detected roadway feature position point falls outside of the mapped line segment vector, system 100 may determine that the mapped line segment vector is not the nearest line segment to the detected roadway feature position point and may selected a different mapped line segment until projection onto the nearest mapped line segment is computed. If the detected roadway feature position point may be projected onto multiple mapped line segments, system 100 may compute the distance between the detected roadway feature position point and its projection onto each mapped line segment, as described below, and select the nearest mapped line segment on the basis that the nearest mapped line segment corresponds to the shortest distance.

Next, system 100 may compute the distance between the detected roadway feature position point and the projection of the point onto the nearest mapped line segment. In some implementations, to compute this distance, system 100 may compute the Manhattan distance or L1 norm between the two points by summing the absolute differences of the coordinates of the two points along each dimension of the coordinate system, for example along the F, L, and U dimensions. In other implementations, system 100 may compute the Euclidean distance between the detected roadway feature position point and the projection of the point onto the nearest mapped line segment, for example by computing the straight-line distance between the two points. In other implementations system 100 may compute the Mahalanobis distance between the detected roadway feature position point and the projection of the point onto the nearest mapped line segment, for example by taking into account map uncertainty model 204 and/or detected uncertainty model 208. As mentioned above, detected and/or map data may be associated with a certain degree of uncertainty that may be modeled as a Gaussian distribution with a mean representing a point of a particular line segment and a covariance matrix representing uncertainty in each coordinate direction, for example in the F, L, and U dimensions. Thus, the aforementioned process may be applied, taking into the covariance matrices of one or both of the detected roadway feature position point and the points forming one or more mapped line segments.

The distances between each point of a detected line segment and/or polyline and its projection onto the nearest mapped line segment may then be averaged, for example by summing the distances and dividing the sum by the number of distances forming the sum. The resulting value 232 may thus represent an averaged distance between the detected and mapped line segments and/or polylines and may form alignment distance 240.

This process of computing the distances between detected points and their projections onto mapped line segments may be advantageous in cases in which line segments in map data 102 are sourced from high-definition or high-accuracy map data, and detected roadway feature position line segments are less accurate, for example due to sensor noise or environmental factors present when detection data 104 was generated. As a secondary determination of alignment distance 240 or in instances in which the accuracy of detection data 104 is comparable to or exceeds that of map data 102, system 100 may compute distances between mapped points and their projections onto detected line segments 224. This process may follow the above-described process steps except that, instead of computing distances between detected points and their projections onto mapped line segments, distances between mapped points and their projections onto detected line segments may be computed. These distances may represent the Manhattan, Euclidean and/or Mahalanobis distance between each set of points, and may be averaged as described above to form value 232. If both projections onto mapped line segments using data 222 and projections onto detected line segments using data 224 are computed, system 100 may use the resulting averages of distances from both sets of data to form alignment distance 240. For example, system 100 may average the two values to form a final alignment distance 240 and/or may form two separate alignment distances 240 to as use an input for the cost function computation.

In this way, alignment distance 240 may represent a distance between a candidate pairing of feature positions including one detected roadway feature position and one mapped roadway feature position. Regardless of whether a pairing represents two discrete roadway features represented by points such as traffic lights and/or traffic signs, or whether the pairing represents two linear roadway features represented by a set of points forming one or more line segments and/or polylines, alignment distance 240 may indicate the proximity of the feature positions of the pairing and may form part of the basis of the cost function computation.

In addition to alignment distance 240, system 100 may take into account semantic information 245. As discussed above, map data 102 and/or detection data 104 may include semantic information providing a classification and/or further context for one or more mapped and/or detected roadway features. Semantic information within map data 102 may have been detected by the techniques used to build the high-definition map data, for example based on satellite images and/or high-resolution roadway feature measurements. Semantic information 245 within detection data 104 may have been detected by the vehicle's perception system, for example by an optical sensor. Semantic information in map data 102 and/or detection data 104 may be assigned based on a machine learning algorithm trained to classify roadway features. This classification may be based on, for example, an indication of one or more types, one or more colors, and/or one or more additional identifiers such as text and/or arrow direction of one or more of the identified roadway features. The machine-learning algorithm, for example a neural network, used to assign semantic information to perceived and/or mapped features may produce a probabilistic model to represent the likelihood or confidence of each assignment. This probabilistic model may serve as an input to the map uncertainty model and/or detection uncertainty model discussed below.

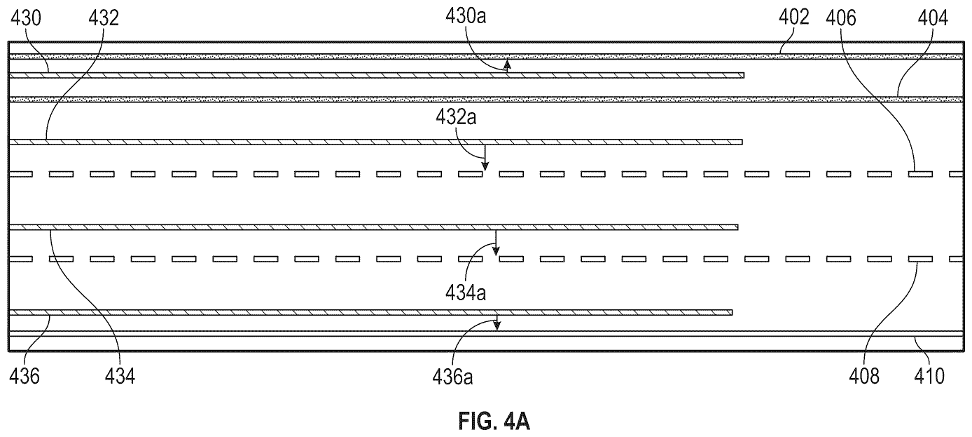

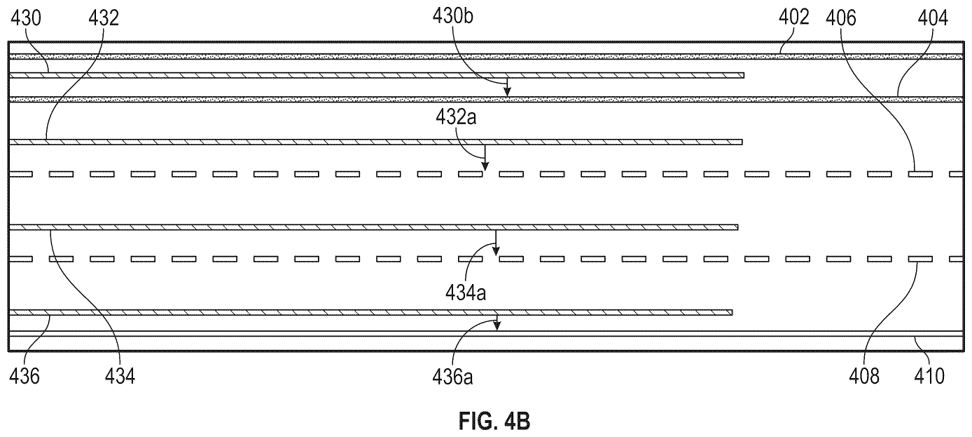

For example, as depicted in FIGS. 4A and 4B, map data may include line segments and/or polylines representing left boundary lane lines 402 and 404, and center lane lines 406 and 408, and/or right boundary lane line 410. Mapped lane lines 402, 404, 406, 408, and 410 may represent the edge positions of physical lane lines. Alternatively or additionally mapped lane lines 402, 404, 406, 408, and 410 may represent the centerline positions of physical lane lines. Map data 102 may further include semantic information 245 indicating the type and color of each lane line. For example left lines 402 and 404 may be classified as type “solid” and color “yellow,” center lines 406 and 408 may be classified as type “dashed” and color “white,” and right line 410 may be classified as type “solid” and color “white.” Detection data may include line segments and/or polylines 430, 432, 434, and 436. If, for example, detection data further included semantic information about detected line 430 matching semantic information about mapped lines 402 and/or 404, classifying detected line as type “solid” and/or as color “yellow,” system 100 may detect this similarity and base the cost function in part on this semantic information. For example, the cost function may be reduced by an amount that corresponds to the degree to which semantic information matches between a pairing of mapped and detected roadway features. For example, if both the type and color classifications match, the cost function may be lower than if only one of the type or color classification match between the mapped and detected roadway features.

If only one of map data 102 and detection data 104 have semantic information, once an alignment between mapped and detected roadway features has been generated, system 100 may add semantic information corresponding to one or more features to the dataset that did not originally include it. For example, if map data 102 is lacking semantic information, post alignment, system 100 may add semantic information that may have been generated by the vehicle's perception system and may correspond to a color and/or type of a roadway feature. This may, for example, improve the quality of future association operations using the map data. Similarly, if detection data 104 is lacking semantic information, post alignment, system 100 may augment detection data with this information, for example to improve driver and/or autonomous driving system awareness of the identity and/or type of roadway features surrounding the vehicle.

Once alignment distance 240 and/or semantic information 245 have been generated, one or both may be used as the basis of the cost function computation at step 250. For example, alignment distance 240 may be normalized by dividing by a maximum or reference distance, and semantic information 245 may be normalized based on the number of matching categories. For example, in the case of map and detection data including two categories (e.g. color and type), system 100 may determine a normalized semantic information value that is 0.5 if one category matches and 1 if both categories match between mapped and detected roadway features. Optionally, the weighting of various categories may be adjusted to, for example, place greater emphasis on matching color over matching type. Normalized alignment distance values may be combined with normalized semantic information values and individually weighted to form the cost function. For example, alignment distance may be weighted to have a greater effect on alignment function relative to semantic information. In implementations in which semantic information is not included in one or both of map data and detection data, the cost function may instead be based on a distance metric that matches that of alignment distance 240, for example meters.

Once the cost function has been formed for each association, based on alignment distance 240 and/or semantic information 245, system 100 may evaluate the value of the cost function as part of branch and bound approach based on individual compatibility as discussed above. Specifically, system 100 may evaluate, through an iterative branching process, whether the cost function exceeds an optionally user-defined cost threshold. At step 260, system 100 may eliminate the association if the cost function of the association exceeds the cost threshold. If the cost function is based on alignment distance 240 and semantic information 245, the cost threshold may correspond to a normalized maximum acceptable value, with system 100 eliminating a particular association if the cost function exceeds this value. If the cost function is based on alignment distance 240, the cost threshold may correspond to a maximum distance, with system 100 discarding a particular association if the cost function of the association equals or exceeds the maximum distance. With an at least partial dependence on alignment distance 240, the branch and bound approach based on individual compatibility may function as a nearest neighbor association, where selecting the lowest cost function association may correspond to selection of the nearest mapped or detected roadway feature position.

System 100 may repeat the elimination process of step 260 for a plurality of pairings, thereby discarding unpromising candidate associations between a detected roadway feature and a mapped roadway feature based on the cost function of each association. This iteration may take the form of, for example, selecting a single discrete detected roadway position and comparing to all discrete mapped roadway positions, selecting a single discrete mapped roadway position and comparing to all discrete detection roadway positions, selecting a single linear detected roadway position and comparing to all linear mapped roadway positions, and/or selecting a single linear mapped roadway position and comparing to all linear detection roadway positions. Alternatively or additionally, system 100 select a subset of roadway positions, determined to be proximate to the single position based on a pre-filtering approach, for comparison to the single roadway position to improve computational efficiency. In some implementations, this subset may be selected based additionally or alternatively on semantic information 245 if available for both mapped and detected roadway features. For example, system 100 may detect that a traffic sign belongs to color classification “red,” and may select for comparison all discrete mapped roadway features within a user-specified or automatically selected proximity and/or that also correspond to color classification “red.”

This iterative branching and eliminating process may continue, with system 100 discarding unpromising associations and continuing to search for more favorable associations until system 100 has generated, at step 270, a set of cost function values that fall below the cost threshold. System 100 may then select the best one or more candidate associations or pairings by selecting the cost function that minimizes the cost, for example the cost function associated with the lowest alignment distance 240.

Because map data 102 may include many more feature positions than detection data 104, the objective of the association process depicted in FIG. 2 may be to associate each detected roadway feature position with a mapped roadway feature position that represents the best association for the corresponding detected roadway feature position. In the case of some detected roadway feature positions, for example those detected by the vehicle's perception system at a significant distance or depth from the vehicle and thus corresponding to a high degree of measurement uncertainty, an association with a mapped roadway feature with a cost function that falls below the cost threshold may not be able to be established. This may represent, in effect, exclusion from the set of associations considered for alignment outlier detections with a high degree of uncertainty that if included in the alignment model would reduce the accuracy of the alignment transformation computation. Thus, system 100 may not always achieve an upper bound on number of associations corresponding to association of every detected roadway feature position.

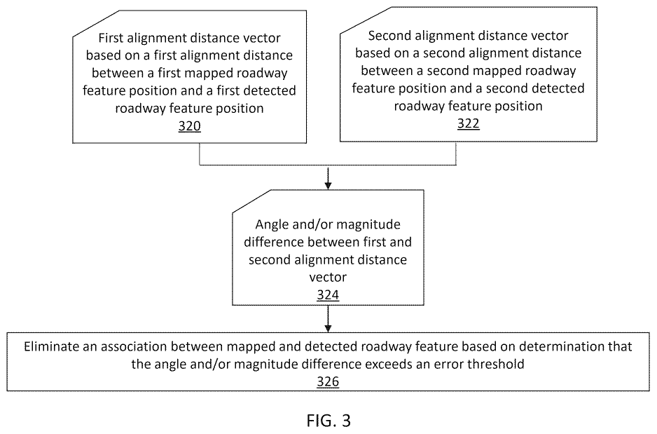

FIG. 3 depicts a further addition to the branch and bound approach, based on joint compatibility and following generation of two or more associations on the basis of individual compatibility. As discussed below, the process depicted in FIG. 3 may be integrated into the branch and bound process of FIG. 2 at step 260, to check whether an association is compatible with one or more other associations. Additionally or alternatively, the process depicted in FIG. 3 may form a check occurring after the branch and bound process of FIG. 2 is completed, used to eliminate associations meeting individual compatibility but found to be inconsistent with one or more other associations.

System 100 may test the joint compatibility of two or more associations of a particular scene, for example a scene associated with a particular set of map data 102 and detection data 104. For example, as depicted in FIGS. 4A and 4B, map data may include line segments and/or polylines representing left boundary lane lines 402 and 404, and center lane lines 406 and 408, and/or right boundary lane line 410. Detection data may include line segments and/or polylines 430, 432, 434, and 436. As part of the branch and bound approach based on individual compatibility, to find the best associations of individual detected and mapped roadway features, system 100 may determine that detected line 430 may be best associated with mapped line 402, detected line 432 with mapped line 406, detected line 434 with mapped line 408, and/or detected line 436 with mapped line 410. Alignment distance vectors 430a, 432a, 434a, and 436a, as depicted in FIG. 4A, represent the alignment distance between the individually associated detected and mapped lines listed above, specifically the direction from the detected feature to the mapped feature.

While 430a represents the minimum distance between detected line 430 and mapped line 402, and thus the best association when evaluated individually, it is apparent based the set of alignment distance vectors that 430a is pointing in an approximately opposite direction to alignment distance vectors 432a, 434a, and 436a, meaning that detected line 430 is likely associated with the wrong mapped line.

To resolve this possibly erroneous association based on a joint compatibility check, system 100 may first compute a first alignment distance vector 320 based on a first alignment distance between a first set of mapped and detected roadway feature positions. System 100 may further compute a second alignment distance vector 322 based on a second alignment distance between a second set of mapped and detected roadway feature positions. System 100 may then compute the difference in angle and/or magnitude between the first and second alignment distance vector. At step 326, system 100 may eliminate an association based on a mapped and detected roadway feature based on a determination that a difference in angle and/or magnitude exceeds an optionally user-defined error threshold. This error threshold may encode both translational and angular errors, and correspond to the norm of the error vector. The joint compatibility test evaluates this set of error vectors for a given hypothesis, re-assessing the consistency of angle and/or magnitude across all error vectors with each potential match added to the hypothesis.

As shown in FIG. 4, system 100 may compute additional alignment distance vectors and generate a difference in angle and/or magnitude between each alignment distance vector. For example, in the case of a set of three alignment distance vectors, system 100 may compute the difference in angle and/or magnitude in orientation between the first and second, first and third, and second and third alignment distance vectors. System 100 may determine if any one of these three differences in angle and/or magnitude exceed the error threshold.

In some implementations, the joint compatibility process may be integrated into the branch and bound process at step 260 of FIG. 2, checking whether an association with a cost function that falls below the cost threshold is compatible with associations with cost functions found to also fall below the cost threshold. In this way, associations that meet individual compatibility may be checked for consistency via the joint compatibility process, based on difference in angle and/or magnitude between alignment distance vectors. In other implementations, joint compatibility may be a check occurring after the branch and bound approach based on individual compatibility is completed, used to eliminate associations meeting individual compatibility that are found to be inconsistent with one or more other associations meeting individual compatibility. In either case, associations meeting individual compatibility may be checked for consistency, based on difference in angle and/or magnitude between alignment distance vectors, with a threshold proportion of other associations meeting individual compatibility. For example, joint compatibility may dictate that an association may have an alignment distance vector that is similar in angle and/or magnitude, for example falling below an error threshold, to a threshold number of other associations. By specifying a quantity of associations and/or an orientation requirement, system 100 may ensure sufficient associations satisfying individual compatibility are available for alignment computation, and/or that a rigid transformation involving only rotation and translation may be computed on the basis of the associations. In the case of multiple competing groups of associations satisfying individual compatibility, with associations of each group internally consistent and satisfying joint compatibility, system 100 may select the group with the highest number of associations as the set of best associations to store in an association data structure as described below. To limit the number of candidate map features considered for association with detected features, system 100 may apply an adaptive threshold that limits candidates to those within a certain proximity of a particular detected feature. This threshold may be dynamically adjusted based on uncertainty of the measurement of the vehicle's position, such that a higher uncertainty may increase the threshold to include more potential candidates, and a lower uncertainty may decrease the threshold to reduce the number of potential candidates.

For example, in FIG. 4A, system 100 may compute the difference in angle and/or magnitude between each of alignment distance vector and all other alignment vectors belonging to the set including 430a, 432a, 434a, and 436a. In this case, the difference in angle and/or magnitude in orientation between each of alignment distance vectors 432a, 434a, and 436a may be relatively low while the difference in angle and/or magnitude between alignment distance vector 430a and each of 432a, 434a, and 436a may be relatively high, possibly exceeding an error threshold. In this case, system 100 may eliminate the association of alignment distance vector 430a, as described at step 326. Following elimination of an association that system 100 assigned the best association following the individual compatibility branch and bound approach, system 100 may return to the set of cost function values, for example a set of alignment distances that fell below a cost threshold, and select the next lowest cost association. Alternatively, if no other associations fell below the cost threshold, system 100 may increase the cost threshold to consider other possible associations determined to be unfavorable based during the initial branching process. This new individual association may then be reintroduced into the joint compatibility process as a replacement association and the difference in angle and/or magnitude between the new association and some or all of the other associations may be compared to determine if each falls below the error threshold. For example, as shown in FIG. 4B, system 100 selected alignment distance vector 430b and association between detected line 430 and mapped line 404 as a replacement association. Since the difference in angle and/or magnitude between alignment distance vector 430b and each 432a, 434a, and 436a may be relatively low, and similar to the difference in angle and/or magnitude between each of alignment distance vectors 432a, 434a, and 436a, system 100 may determine that all differences in angle and/or magnitude fall below the error threshold and thus that the set of associations has passed the joint compatibility test.

To ensure there are sufficient associations to enable an accurate computation of an alignment transformation and/or vehicle pose, system 100 may impose one or more association requirements. For example, system 100 may require that at least two associations of a particular scene or dataset include linear roadway features. This requirement may be satisfied by, for example, the inclusion of two associations representing lane line features, for example two associations between mapped and detected feature positions that each correspond to a lane line feature.

Returning to step 120 of FIG. 1B, once a best association has been determined for one or more mapped and/or detected roadway features, optionally checked using the above joint compatibility test, at step 126, system 100 may generate an association data structure, for example a vector, to store the association data. Association data stored in the data structure may include, for example, the identifier and/or the position of the mapped roadway feature and the identifier and/or the position of the detected roadway feature that were determined to correspond to the best association at step 124.

Next, at step 130 system 100 may determine an alignment transformation, based on the association data determined at step 120, that minimizes the positional error between the detected and mapped roadway features. This may take the form of a rigid transformation, that is a transformation that involves only rotation and translation without scaling or deformation of the corresponding roadway features. The transformation may be sufficient to minimize the alignment error between the detected and mapped roadway features, whether by transforming the mapped roadway feature positions and/or by transforming the detected roadway feature positions. The alignment transformation may be represented by a rotational matrix and/or a translation vector, and/or by a transformation matrix incorporating both rotational and translational information.

As discussed above, prior to conversion to the FLU coordinate system, the mapped roadway feature positions may or may not have been projected to a planar surface within the ENU local Cartesian coordinate system, for example the tangent plane of the ENU coordinate system, e.g. the plane located at an upward axis position of 0. If the positions were not projected to a planar surface, the transformation may take place in full 3D space and may belong to Special Euclidean group in 3 dimensions or SE(3). If the positions were projected to a planar surface, the transformation may take place in planar, or 2D space and may belong to Special Euclidean group in 2 dimensions or SE(2). In SE(3), a rigid transformation matrix may take the form of a 4×4 matrix accounting for both a 3D rotation matrix and a 3D translation vector. In SE(2), a rigid transformation matrix may take the form of a 3×3 matrix accounting for both a 2D rotation matrix and a 2D translation vector.

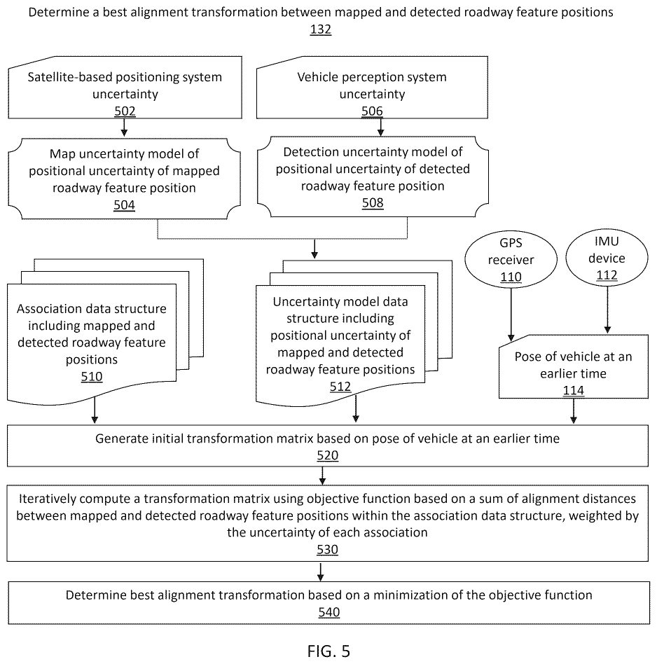

To determine a best alignment transformation between mapped and detected roadway figures at step 132, as depicted in FIG. 5, a transformation matrix that minimizes alignment error may be generated and/or selected at steps 520, 530, and/or 540. This transformation matrix may be based on an association data structure 510 generated at step 126 and may include the positions in FLU coordinates of associations of mapped roadway features and detected roadway features. These associations may be those associations that correspond to a minimized cost function, for example satisfying individual compatibility, and/or that satisfy joint compatibility by, for example, having an alignment distance vector orientation that in comparison to vector orientations of other associations fall below an error threshold. The alignment transformation computation may also take into account an uncertainty data structure 512 optionally including the positional uncertainty associated with each mapped and detected roadway feature position present in association data structure 510.

Uncertainty model data 512 may be based on map uncertainty model 504 which, as described above, may model the positional uncertainty associated with each mapped roadway feature position. This model in turn may be based on the measurement uncertainty 502 derived from the satellite-based positioning used to generate map data 102. For example, satellite-based positioning system uncertainty may be caused by precision limits inherent in the positioning system, for example a GPS system. Such uncertainty may additionally or alternatively be caused by conversion of mapped roadway feature positions from the geodetic coordinate system in which it was measured to a local Cartesian coordinate system centered on an approximate position of the vehicle, a conversion which may be based on a current and prior or reference position of the vehicle that itself may be based on such a positioning system with its own precision limitation.

Uncertainty model data 512 may additionally be based on detection uncertainty model 508 which, as described above, may model the positional uncertainty associated with each detected roadway feature position. This measurement uncertainty 506 may be the result of limitations on precision of a vehicle's perception system, for example one or more LiDAR, optical, and/or radar sensors. These limitations in turn may be the result of environmental factors such as differing lighting, reflectivity, presence of precipitation, and/or occlusions by other roadway actors. Both map uncertainty model 504 and detection uncertainty model 508 may be based on probabilistic distributions, such as Gaussian distributions, where a mean represents an expected position, and a covariance matrix captures the variability and correlation between positions along different coordinate axes, reflecting the degree of confidence in the map data.

As discussed above, detections by the vehicle's perception system of objects and/or roadway features located a significant distance from the vehicle may be less accurate and/or less reliable than detections of roadway features located closer to the vehicle. For this reason, system 100 may assign a higher degree of uncertainty to detected roadway features positions located further from the vehicle. This increase in uncertainty as a function of depth, for example depth detected by one or more LiDAR sensors, may be implemented as a threshold, for example increasing by a certain amount at a threshold depth. Additionally or alternatively, uncertainty may be increased linearly and/or exponentially as a function of depth. Such a detection uncertainty model 508 may thus be considered conal in nature, with noise and/or uncertainty in model data increasing as the distance from the vehicle increases.

Uncertainty models 504 and 508, and/or covariance matrices included within each model, may be the basis for down weighting or whitening associations with high uncertainties such that they have less of an effect on the alignment transformation computation. Specifically, as described below, the effect of the alignment distance or alignment error of associations corresponding to high uncertainty may be given lower weight to ensure system 100 gives higher weight to higher confidence associations based on lower uncertainty data, for example including associations of roadway features located close to the vehicle.

As mentioned above, the alignment transformation matrix computation may take into account both association data structure 510 and uncertainty model data structure 512. System 100 may begin by generating, at step 520, a transformation matrix based on the pose of the vehicle at an earlier time 114. This earlier pose may be based on positional inputs from GPS receiver 110 and/or IMU device 112, measuring the position and inertial motion of the vehicle and/or may be based on the pose of the vehicle computed during a previous cycle. As with determination of association data, this initial estimate of vehicle pose may then be further refined via the below alignment computation process. As mentioned above the transformation matrix may be represented by a single matrix and/or by a rotation matrix in combination with a translation vector.

At step 530, further refinements to the transformation matrix may be computed iteratively using a weighted least squares optimization approach with the objective of minimizing the alignment error between the mapped and detected feature positions corresponding to each association of features. This may be accomplished using an objective function that minimizes the sum of errors or residuals representing the alignment distance between each mapped and detected feature of each association, with one or more alignment distances weighted based on uncertainty associated with the mapped and/or detected feature positions making up the association. Alignment distances may be computed in a similar manner to that described in FIG. 2. For discrete roadway features, the Mahalanobis, Euclidean, and/or Manhattan distance may be computed between points representing mapped and detected roadway features. For linear roadway features, an average of the Mahalanobis, Euclidean, and/or Manhattan distances may be computed between a detected feature point and its projection onto a mapped feature line and/or between a mapped feature point and its projection onto a detected feature line.

Thus, at step 530, system 100 will solve the objective function for a total error value representing a sum of the alignment distances between the mapped and detected roadway features of each association. The alignment distances of each association may be weighted by an information matrix, which may represent an inverse of the covariance matrix. Whereas the covariance matrix increases as a function of uncertainty, the information matrix decreases as a function of uncertainty, thereby ensuring that associations that uncertainty model data structure 512 indicate correspond to a high degree of uncertainty are down weighted relative to associations with a lower degree of uncertainty. As discussed above, associations may be associated with higher uncertainty if the mapped and/or detected feature position is uncertain, due to measurement uncertainty in the map and/or detection data, for example due to a feature detected by the perception system at a significant distance from the vehicle.

To iteratively improve the estimate of the alignment transformation matrix, system 100 may employ a nonlinear solver, for example a Gauss-Newton, a Levenberg-Marquardt, and/or a gradient-descent method. At each iteration, the solver may modify the transformation matrix and compute the optimization function with the objective of minimizing the sum of the alignment errors of each association computed by the optimization function. The updated transformation matrix at each step, computed by the nonlinear solver may be based on the way the sum of alignment errors change with respect to corresponding changes to the transformation matrix. For example, the nonlinear solver may compute a Jacobian matrix to produce an approximation of the rate of change or gradient representing change in the alignment error sum with respect to change to the transformation matrix.

This iterative process may continue until the optimization function or total alignment error falls below an error threshold or the gradient in improvement is sufficiently small. At this point, the nonlinear solver may determine that the solution has converged and the alignment error has been minimized. At this point, system 100 may at step 540 determine the best or final alignment transformation based on minimization of the objective function.

Returning to FIG. 1B, following determination of the alignment transformation at step 130, system 100 may use the alignment transformation matrix that was computed to transform a plurality of mapped roadway feature positions to align the mapped roadway feature positions with the detected roadway feature positions at step 140. With the mapped roadway feature positions aligned with the detected roadway feature positions, system 100 can now, at step 142, use these mapped feature positions to localize the vehicle to at least the positional accuracy of a lane line and/or to compute an updated pose of the vehicle. This updated pose may be based on the positions of the mapped features in the global coordinate system in which they were measured, included within map data 102, and the transformations necessary to convert them first to the ENU local Cartesian coordinate system, then to the FLU vehicle coordinate system, and to align them based on the above-described alignment process.

Alternatively or additionally, once the mapped feature positions have been aligned to the detected feature positions, system 100 may convert the detected feature positions from the vehicle coordinate system to the global coordinate system in which the mapped feature positions were measured. System 100 may accomplish this by converting the detected feature positions first to the ENU coordinate system based on a rotation matrix and/or translation vector as described above, and from the ENU coordinate system to the ECEF coordinate system based on a current and a prior or reference position of the vehicle as described above. System 100 may then convert the detected feature positions from the ECEF coordinate system to the global coordinate system in which the mapped feature positions were measured, for example the WGS84 global geodetic coordinate system. With the detected roadway feature positions in the same global coordinate system as the mapped roadway feature positions, system 100 can use these detected feature positions to localize the vehicle to at least the positional accuracy of a lane line and/or to compute an update pose of the vehicle. This updated pose may be based on the positions of the detected features in the vehicle coordinate system in which they were measured, included within detection data 104, and the transformations necessary to align them based on the above-described alignment process, and to convert them first to the ENU coordinate system, then to the global coordinate system.

The process represented by FIG. 1B may be repeated cyclically as the vehicle passes along a roadway environment. As new detection data 104 and map data 102 become available, corresponding to a new scene surrounding the vehicle, system 100 may use the updated pose computed at step 142 and as the basis for pose input 114 which, along with map data 102 and detection data 104, may form the inputs to compute a set of associations and a transformation to align the features of the set of associations, thereby computing an updated vehicle pose corresponding to the new scene. This pose computation may be based on transforming mapped roadway features based on the alignment transformation or on transforming the detected roadway features based on the alignment transformation and converting the detected roadway features to the global coordinate system. In either case, system 100 may provide the transformed mapped roadway features and/or the transformed detected roadway features as an input to one or more control systems of, for example, an autonomous vehicle. This transformation may enable the one or more control systems to incorporate additional forms of data into decision-making processes. For example, prior to the transformation, the one or more control systems may not have been able to rely on the position of roadway features in at least one of map data 102 or detection data 104. Following transformation of one or both of the mapped and/or detected roadway features, the one or more control systems may fuse these two sources of roadway feature information, enabling a higher fidelity understanding of the vehicle's surrounding.

System 100 may operate on one or more sensor pods or sensor arrays and may generate alignment transformations and vehicle poses independently for each pod or array. The vehicle may include a pose fusion model that may produce a global vehicle pose estimate. In this case, pose estimates from individual sensor arrays may form different unary factors in the pose fusion model. Outputs generated by system 100 may be published to, for example, a graphical user interface, for example the results of the association and/or alignment processes. For example, the association process may publish the number of associated roadway features and their corresponding identifiers. For example, the alignment process may publish the number of iterations made before the nonlinear solver converged and/or values associated with the optimization function.

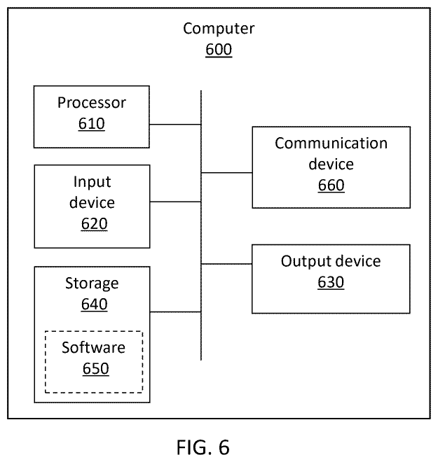

In one or more examples, the disclosed systems and methods utilize or may include a computer system. FIG. 6 depicts an exemplary computing system according to one or more examples of the disclosure. Computer 600 can be a host computer connected to a network. Computer 600 can be a client computer or a server. As shown in FIG. 6, computer 600 can be any suitable type of microprocessor-based device, such as a personal computer, workstation, server, or handheld computing device, such as a phone or tablet. The computer can include, for example, one or more of processor 610, input device 620, output device 630, storage 640, and communication device 660. Input device 620 and output device 630 can correspond to those described above and can either be connectable or integrated with the computer.

Input device 620 can be any suitable device that provides input, such as a touch screen or monitor, keyboard, mouse, or voice-recognition device. Output device 630 can be any suitable device that provides an output, such as a touch screen, monitor, printer, disk drive, or speaker.

Storage 640 can be any suitable device that provides storage, such as an electrical, magnetic, or optical memory, including a random-access memory (RAM), cache, hard drive, CD-ROM drive, tape drive, or removable storage disk. Communication device 660 can include any suitable device capable of transmitting and receiving signals over a network, such as a network interface chip or card. The components of the computer can be connected in any suitable manner, such as via a physical bus or wirelessly. Storage 640 can be a non-transitory computer-readable storage medium comprising one or more programs, which, when executed by one or more processors, such as processor 610, cause the one or more processors to execute methods described herein.

Software 650, which can be stored in storage 640 and executed by processor 610, can include, for example, the programming that embodies the functionality of the present disclosure (e.g., as embodied in the systems, computers, servers, and/or devices as described above). In one or more examples, software 650 can include a combination of servers such as application servers and database servers.

Software 650 can also be stored and/or transported within any computer-readable storage medium for use by or in connection with an instruction execution system, apparatus, or device, such as those detailed above, that can fetch and execute instructions associated with the software from the instruction execution system, apparatus, or device. In the context of this disclosure, a computer-readable storage medium can be any medium, such as storage 640, that can contain or store programming for use by or in connection with an instruction execution system, apparatus, or device.

Software 650 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 600 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 600 can implement any operating system suitable for operating on the network. Software 650 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. A method for localizing a vehicle, the method comprising:
receiving map data comprising a plurality of mapped roadway feature positions, wherein at least one of the plurality of positions is represented by a point in a global coordinate system and at least one of the plurality of positions is represented by a line segment comprising two points in the global coordinate system;
receiving detection data comprising a plurality of detected roadway feature positions, wherein at least one of the plurality of positions is represented by a point in a vehicle coordinate system and at least one of the plurality of positions is represented by a line segment comprising two points in the vehicle coordinate system;
receiving a pose of the vehicle at an earlier time;
determining association data between one or more of the plurality of mapped roadway feature positions and one or more of the plurality of detected roadway feature positions based on the pose of the vehicle at the earlier time and at least one of:
a distance between a point representing a detected roadway feature position and a line segment representing a mapped roadway feature position; or
a distance between a point representing a mapped roadway feature position and a line segment representing a detected roadway feature position;
determining an alignment transformation, based on the association data, that minimizes an alignment distance between the one or more of the plurality of mapped roadway feature positions and the one or more of the plurality of detected roadway feature positions; and
computing an updated pose of the vehicle based on the map data and the alignment transformation.

2. The method of claim 1, wherein at least one of the plurality of mapped roadway features or the plurality of detected roadway features is at least one of a lane line, a roadway sign, a traffic light, a roadway marking, or a roadway pole.

3. The method of claim 1, wherein the pose of the vehicle at an earlier time is based on a signal from at least one of a satellite-based positioning system or an inertial measurement device.

4. The method of claim 1, wherein the detection data was generated by at least one sensor selected from a group comprising an optical sensor, a LiDAR sensor, and a radar sensor.

5. The method of claim 1, wherein determining the association data comprises:
converting the one or more of the plurality of mapped roadway feature positions from the global coordinate system to the vehicle coordinate system.

6. The method of claim 1, wherein determining the association data comprises:
converting the one or more of the plurality of mapped roadway feature positions from the global coordinate system to a local Cartesian coordinate system and from the local Cartesian coordinate system to the vehicle coordinate system.

7. The method of claim 6, wherein determining the association data comprises projecting the one or more of the plurality of mapped roadway feature positions onto a planar surface defined by the local Cartesian coordinate system.

8. The method of claim 1, wherein determining the association data comprises:
eliminating a first association between a first mapped roadway feature position and a first detected roadway feature position based on a determination that a first cost function of the first association exceeds a cost threshold; and
selecting, for inclusion in the association data, a second association between a second mapped roadway feature position and a second detected roadway feature position based on a determination that a second cost function of the second association is lower than a third cost function of a third association.

9. The method of claim 8, wherein at least one of the first cost function, the second cost function, or the third cost function is based on at least one of:
an alignment distance between a mapped roadway feature position of the one or more of the plurality of mapped roadway feature positions and a detected roadway feature position of the one or more of the plurality of detected roadway feature positions; or
an attribute of at least one of the mapped roadway feature or the detected roadway feature, wherein the attribute is selected from a group comprising: a color and a type.

10. The method of claim 9, wherein:
the alignment distance is based on a distance between a point representing a mapped roadway feature position of the one or more of the plurality of mapped roadway feature positions and a point representing a detected roadway feature position of the one or more of the plurality of detected roadway feature positions; and
the alignment distance is based on at least one of a Mahalanobis distance, a Euclidean distance, or a Manhattan distance.

11. The method of claim 10, wherein the Mahalanobis distance is based on at least one of:
a map uncertainty model based on measurement uncertainty associated with a satellite-based positioning system; or
a detection uncertainty model based on measurement uncertainty associated with a perception system of the vehicle.

12. The method of claim 9, wherein:
the alignment distance is based on a distance between at least one of:
a point representing the detected roadway feature position and a projection of the point onto a line segment representing the mapped roadway feature position; or
a point representing the mapped roadway feature position and a projection of the point onto a line segment representing the detected roadway feature position; and
the alignment distance is based on at least one of a Mahalanobis distance, a Euclidean distance, or a Manhattan distance.

13. The method of claim 10, wherein the Mahalanobis distance is based on at least one of:
a map uncertainty model based on measurement uncertainty associated with a satellite-based positioning system; or
a detection uncertainty model based on measurement uncertainty associated with a perception system of the vehicle.

14. The method of claim 1, wherein determining the association data comprises:
computing a difference between an angle of a first alignment distance vector and an angle of a second alignment distance vector; and
eliminating an association between a mapped roadway feature position and a detected roadway feature position based on a determination that the difference exceeds an error threshold;
wherein the first alignment distance vector is based on a first alignment distance between a first mapped roadway feature position and a first detected roadway feature position; and
wherein the second alignment distance vector is based on a second alignment distance between a second mapped roadway feature position and a second detected roadway feature position.

15. The method of claim 8, wherein determining the association data further comprises generating a data structure comprising at least one of:
an identifier of the second mapped roadway feature position and an identifier of the second detected roadway feature position; or
a position of the second mapped roadway feature position and a position of the second detected roadway feature position.

16. The method of claim 1, wherein minimizing the alignment distance between the one or more of the plurality of mapped roadway feature positions and the one or more of the plurality of detected roadway feature positions comprises minimizing an objective function.

17. The method of claim 16, wherein the objective function is based on:
the association data; and
uncertainty model data comprising a positional uncertainty of the one or more of the plurality of mapped roadway feature positions in the association data and a positional uncertainty of the one or more of the plurality of detected roadway feature positions in the association data;
wherein the uncertainty model data is based on:
a map uncertainty model based on measurement uncertainty associated with a satellite-based positioning system; and
a detection uncertainty model based on measurement uncertainty associated with a perception system of the vehicle.

18. The method of claim 16, wherein the objective function is based on a sum of alignment distances, wherein each alignment distance is based on one of the one or more of the plurality of mapped roadway feature positions in the association data and one of the one or more of the plurality of detected roadway feature positions in the association data.

19. The method of claim 18, wherein at least one of the alignment distances of the sum of alignment distances is weighted based on the uncertainty model data.

20. The method of claim 18, wherein at least one of the alignment distances of the sum of alignment distances is based on:
a point representing a mapped roadway feature position of the one or more of the plurality of mapped roadway feature positions and a point representing a detected roadway feature position of the one or more of the plurality of detected roadway feature positions; and
at least one of a Mahalanobis distance, a Euclidean distance, or a Manhattan distance.

21. The method of claim 18, wherein at least one of the alignment distances of the sum of alignment distances is based on:
at least one of:
a point representing a detected roadway feature position and a projection of the point onto a line segment representing a mapped roadway feature position; or
a point representing a mapped roadway feature position and a projection of the point onto a line segment representing a detected roadway feature position; and
at least one of a Mahalanobis distance, a Euclidean distance, or a Manhattan distance.

22. The method of claim 16, wherein minimizing the objective function comprises generating one or more alignment transformations using a nonlinear solver.

23. The method of claim 9, wherein the method further comprises updating the map data, based on the association data, to include the attribute of the at least one of the mapped roadway feature or the detected roadway feature.

24. The method of claim 1, wherein the method further comprises transforming, based on the alignment transformation, at least one feature position selected from a group consisting of: the plurality of mapped roadway feature positions and the plurality of detected roadway feature positions.

25. The method of claim 24, wherein transforming the at least one feature position comprises:
transforming, based on the alignment transformation, the plurality of mapped roadway feature positions to minimize the alignment distance between the one or more of the plurality of mapped roadway feature positions and the one or more of the plurality of detected roadway feature positions.

26. The method of claim 25, wherein the method further comprises providing the transformed plurality of mapped roadway feature positions as an input to one or more control systems of the vehicle.

27. The method of claim 24, wherein transforming the at least one feature position comprises:
transforming, based on the alignment transformation, the plurality of detected roadway feature positions to minimize the alignment position between the plurality of mapped roadway feature positions and the plurality of detected roadway feature positions; and
converting the transformed plurality of detected roadway feature positions from the vehicle coordinate system to the global coordinate system.

28. The method of claim 27, wherein the method further comprises providing the transformed plurality of detected roadway feature positions as an input to one or more control systems of the vehicle.

29. A system for localizing a vehicle, the system comprising one or more processors and memory storing instructions that, when executed by the one or more processors, cause the system to:
receive map data comprising a plurality of mapped roadway feature positions, wherein at least one of the plurality of positions is represented by a point in a global coordinate system and at least one of the plurality of positions is represented by a line segment comprising two points in the global coordinate system;
receive detection data comprising a plurality of detected roadway feature positions, wherein at least one of the plurality of positions is represented by a point in a vehicle coordinate system and at least one of the plurality of positions is represented by a line segment comprising two points in the vehicle coordinate system;
receive a pose of the vehicle at an earlier time;
determine association data between one or more of the plurality of mapped roadway feature positions and one or more of the plurality of detected roadway feature positions based on the pose of the vehicle at the earlier time and at least one of:
a distance between a point representing a detected roadway feature position and a line segment representing a mapped roadway feature position; or
a distance between a point representing a mapped roadway feature position and a line segment representing a detected roadway feature position;
determine an alignment transformation, based on the association data, that minimizes an alignment distance between the one or more of the plurality of mapped roadway feature positions and the one or more of the plurality of detected roadway feature positions; and
compute an updated pose of the vehicle based on the map data and the alignment transformation.

30. A non-transitory computer readable storage medium storing instructions for localizing a vehicle, wherein the instructions, when executed by one or more processors of an electronic device, cause the device to:
receive map data comprising a plurality of mapped roadway feature positions, wherein at least one of the plurality of positions is represented by a point in a global coordinate system and at least one of the plurality of positions is represented by a line segment comprising two points in the global coordinate system;
receive detection data comprising a plurality of detected roadway feature positions, wherein at least one of the plurality of positions is represented by a point in a vehicle coordinate system and at least one of the plurality of positions is represented by a line segment comprising two points in the vehicle coordinate system;
receive a pose of the vehicle at an earlier time;
determine association data between one or more of the plurality of mapped roadway feature positions and one or more of the plurality of detected roadway feature positions based on the pose of the vehicle at the earlier time and at least one of:
a distance between a point representing a detected roadway feature position and a line segment representing a mapped roadway feature position; or
a distance between a point representing a mapped roadway feature position and a line segment representing a detected roadway feature position;
determine an alignment transformation, based on the association data, that minimizes an alignment distance between the one or more of the plurality of mapped roadway feature positions and the one or more of the plurality of detected roadway feature positions; and
compute an updated pose of the vehicle based on the map data and the alignment transformation.
